(19) United States
(12) Patent Application Publication
(10) Pub. No.: US 2002/0152593 A1
(43) Pub. Date: Oct. 24, 2002

(54) Coupling self-locking hook

(76) Inventor: Steven Hong, Taichung (TW)

Correspondence Address: Steven Hong, 235 Chung-Ho, Box 8-24, Taipei, TW

(21) Appl. No.: 09/838,108

(22) Filed: Apr. 20, 2001

(51) Int. Cl. F16B 45/02

(52) U.S. Cl. 24/599.1

(57) ABSTRACT

A coupling self-locking hook consisting of a hook annulus body having pivotably conjoined to its upper extent a hoisting shackle, the boom end of which has a plurality of upward facing openings that serve as a directional clamp slot and, furthermore, active rigging components of various specifications can be installed to the directional clamp slot and thereby provide for suspending and securing from different rigging components. After the hoisting shackle is rotated via a support point provided at a conjoinment position to the maximum angle, the press section of the hoisting shackle is pushed against the position lock of the body to maintain its active angle. The hoisting shackle of the self-locking hook can be secured to various types of active rigging components for increased practicality.

### BACKGROUND OF THE INVENTION

1) Field of the Invention

The invention herein relates to a coupling self-locking hook in which the hoisting shank of the hook annulus has formed in its boom end a plurality of upward facing openings and, furthermore, serve as a directional clamp slot that provides for the installation of various active rigging components; furthermore, the hoisting shackle has projecting from the boom end a stop tab and situated inside a U-shaped clevis section of the body is a position lock, thereby providing for a maximum angle between the hoisting shank and the body as well as the lifting of objects; as such, the hook of the present invention is suitable for applications in which active rigging components can be installed to accommodate different situations and thereby achieves a coupling self-locking hook of high practicality.

2) Description of the Prior Art

As indicated in FIG. 1, a conventional self-locking hook structure consists of a hoisting shank 2 of an annulus hook having disposed at the top end a circular suspending section 25, with a crane hook 7 situated at the top end of the hook annulus, thereby providing for the preliminary placement of the suspending section 25 of the hook annulus onto the body of the crane hook 7; steel cable is then slipped over the hanging hook 12 of the body and, furthermore, the other end of the steel cable is hooked to the object to be lifted, thereby providing for moving the lifted object; however, the said conventional self-locking hook is hampered by its structural limitations and can only provide for a hook conjoinment by attaching a steel cable onto the body of the hook and other types of active rigging components cannot be utilized, as such, the shortcomings include poor usability and narrow application.

### SUMMARY OF THE INVENTION

The primary objective of the invention herein is to provide a coupling self-locking hook in which the hoisting shank of the hook annulus has formed in its boom end a plurality of upward facing openings serving as a directional clamp slot that provides for the installation of various active rigging components and thereby provides for the suspension and securing from different rigging components; furthermore, the hoisting shackle has projecting from the boom a stop tab and situated on the body is a position lock; after the hoisting shackle is rotated via a support point provided at a conjoinment position to the maximum angle, the press section of the hoisting shackle is pushed against the position lock of the body to maintain the hoisting shank at a set angle and thereby provide for lifting objects; as such, the hoisting shank of the hook annulus can be secured to different types of active rigging components such that hook annulus is suitable for applications in which active rigging components must be installed to accommodate different situations, thereby achieving a coupling self-locking hook of high practicality and, furthermore, capable of convenient and rapid operation.

### BRIEF DESCRIPTION OF THE DRAWINGS

FIG. 1 is an isometric drawing of a conventional self-locking hook structure.

FIG. 2 is an exploded drawing of the invention herein.

FIG. 3 is an isometric drawing of the invention herein.

FIG. 4-A is an orthographic drawing of a working embodiment of the invention herein. (1)

FIG. 4-B is an orthographic drawing of a working embodiment of the invention herein. (2)

FIG. 5 is an orthographic drawing of a chain-type active rigging component-driven hook structure.

FIG. 6 is an orthographic drawing of an embodiment having a chain-type active rigging component with an additionally installed insulator swivel ring.

FIG. 7 is an orthographic drawing of a belt-type active rigging component-driven hook structure.

FIG. 8 is an orthographic drawing of another belt-type active rigging component embodiment.

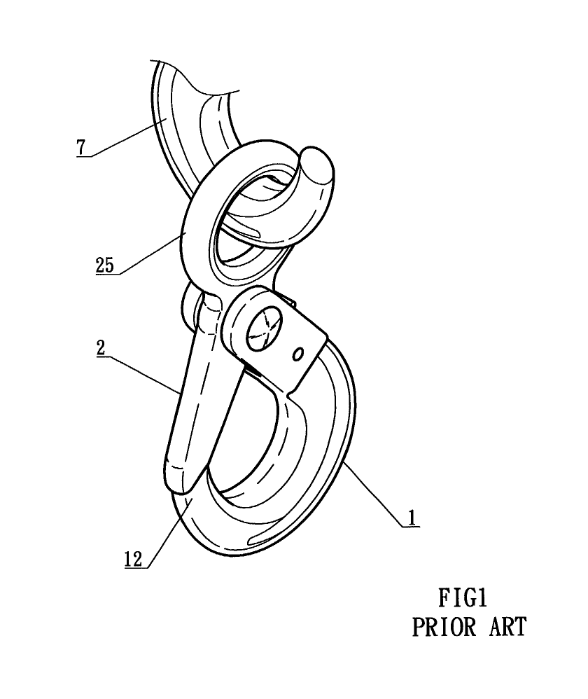

### DETAILED DESCRIPTION OF THE INVENTION

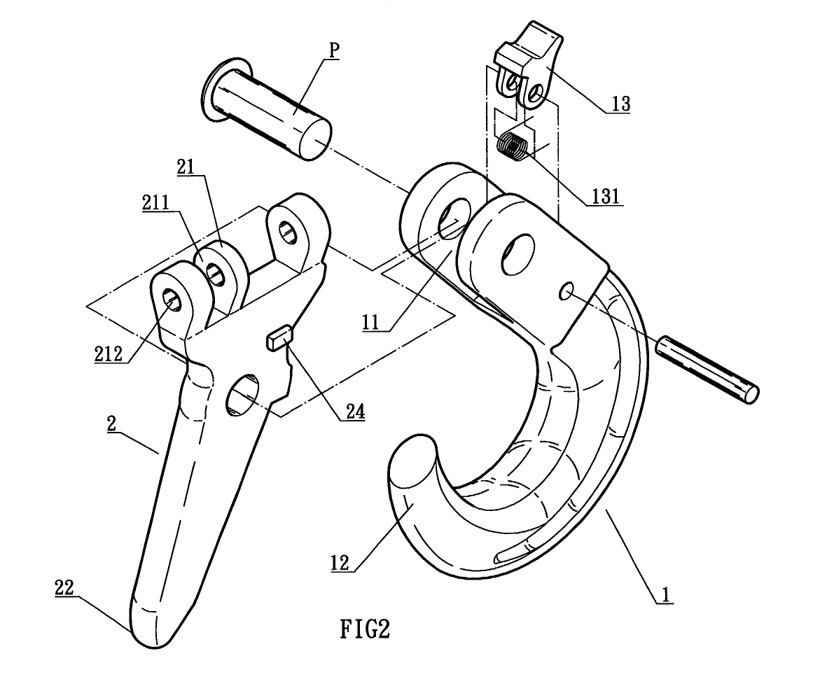

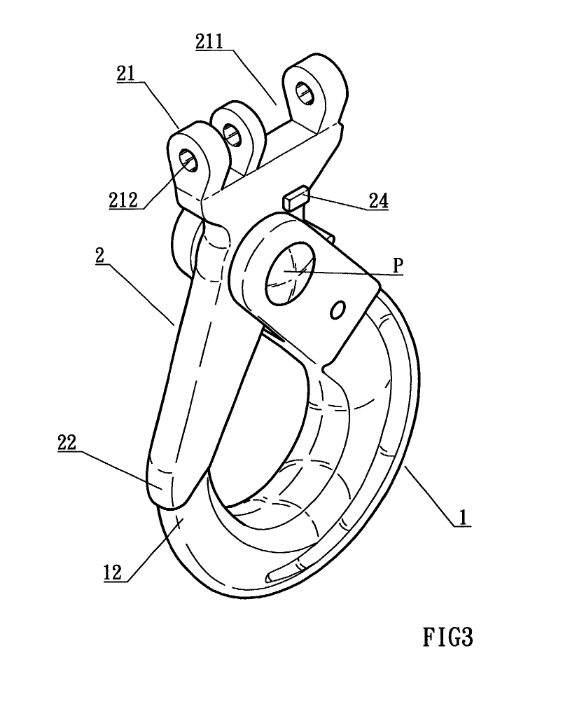

Referring to FIG. 2 and FIG. 3, the structural arrangement of the present invention, the invention herein is comprised of a hook annulus body 1 and a pivot pin P inserted into a hoisting shackle 2 at the upper extent of the body 1, of which:

The said body 1 has formed in its upper lateral face a horizontally recessed U-shaped clevis section 11 and, furthermore, the lower section of the body 1 curves upward and assumes a hook shape that provides a self-locking hook 12 structure for lifting objects; furthermore, situated inside the U-shaped clevis section 11 of the body 1 is a position lock 13.

The said position lock 13 has disposed within it a torsion spring 131 and, furthermore, the position lock 13 is first pivoted to change the shape of the torsion spring 131 until the top end of the position lock 13 is pushed against the hoisting shackle 2, and by simply pressing downward and, furthermore, after the pressure is released, the torsion spring 131 is restored back to its original arrangement and situates the hoisting shackle 2 at the required angle.

The said hoisting shackle 2 consists of a boom end 21 at the upper extent of a conjoinment section and a latch end 22 aligned with and contacting the body 1 and the self-locking 12; the said boom end 21 has a plurality of upward facing openings serving as a directional clamp slot 211 and, furthermore, all the partition layers of the directional clamp slot 211 have formed in them a through-hole 212; the directional clamp slot 211 of the boom end 21 provides for the installation of various active rigging components (A, B, C, and D) and, furthermore, after the boom end 21 is installed to the active rigging components, a bolt P1 is sequentially inserted into the through-hole 212 and active rigging components and secured to fasten the active rigging components onto the directional clamp slot 211 of the boom end 21.

The said hoisting shackle 2 is proximal to a conjoinment position Q which is of a stepped profile and, furthermore, proximal to the top of the position lock 13 is a press section 23 that enables to the position lock 13 to keep the hoisting shackle 2 stationary; furthermore, the hoisting shackle 2 has projected from the boom end 21 a stop tab 24 that provides a support point for the hoisting shackle 2 at the conjoinment position Q and its rotational situating to the maximum angle.

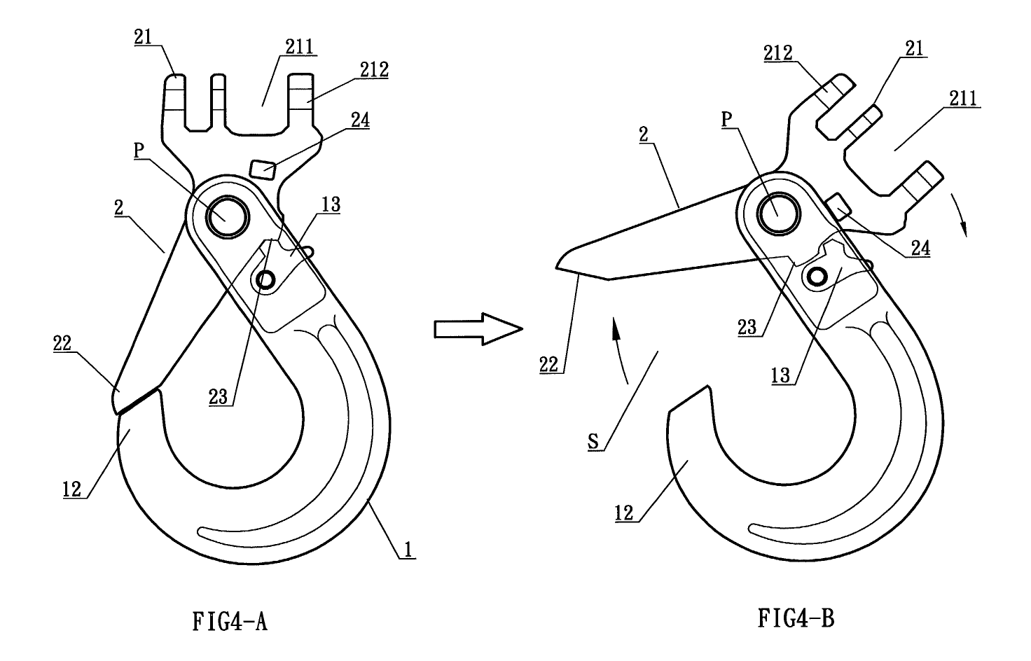

Referring to FIG. 4, the drawing of a working embodiment of the invention herein, pressing down the position lock 13 enables the disengagement of the hoisting shackle 2 from the position lock 13 and its upward rotation to the stop tab 24 against the lateral edge of the body 1 (i.e., the hoisting shackle 2 is rotated upward to its maximum angle); furthermore, after the hoisting shackle 2 has rotated, its press section 23 is pushed against the top end of the position lock 13 to maintain the angle of the hoisting shackle 2 such that an insertion space S is formed between the bottom end of the hoisting shackle 2 and the body 1, at which time the object to be lifted is placed into the insertion space S and suspended on the self-locking hook 12 of the body 1.(as shown in FIG. 4-A); the hoisting shackle 2 is then rotated downward which causes the press section 23 steps to force down the position lock 13 and release the engagement of the press section 23 such that the hoisting shackle 2 rotates back down to its original position (as shown in FIG. 4-B).

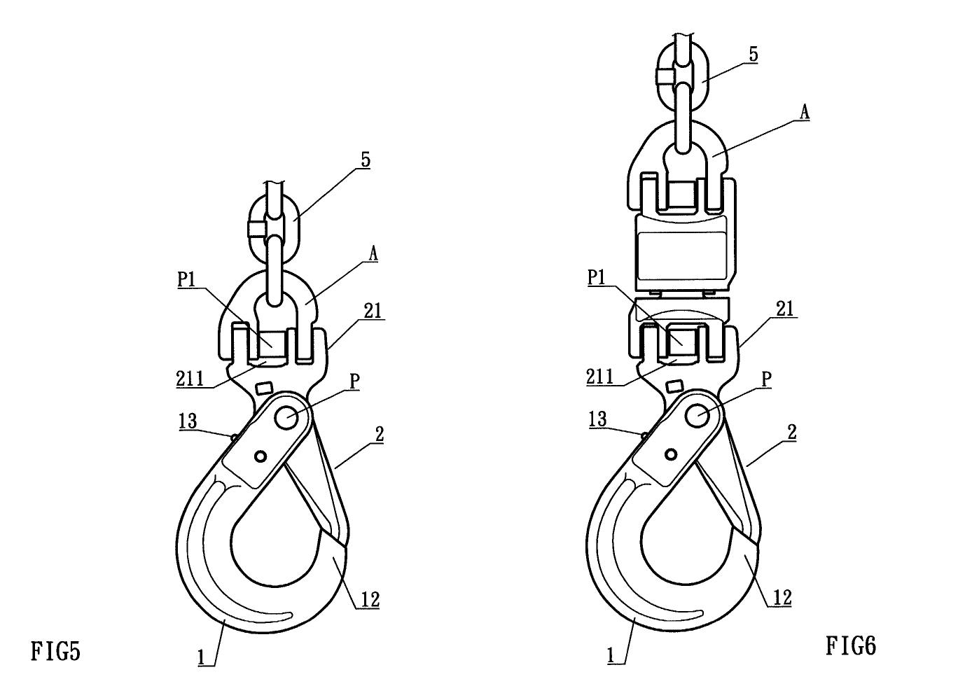

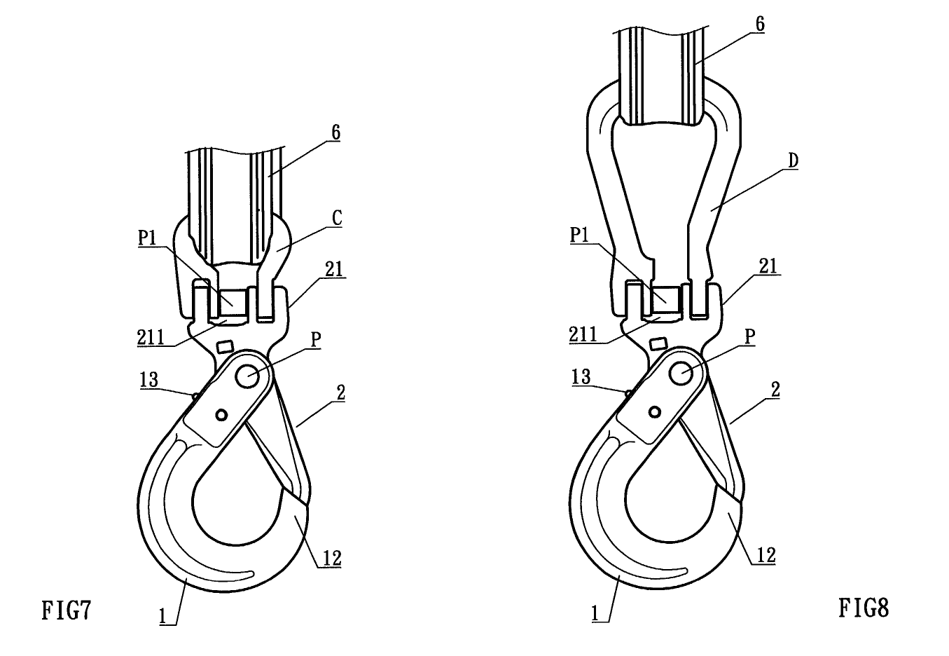

Referring to FIG. 5, FIG. 6, FIG. 7, and FIG. 8, the drawings of various active rigging component embodiments of the invention herein, wherein:

In FIG. 5, the bottom end is symmetrical with the directional clamp slot 211 of the hoisting shackle 2 and, furthermore, the top end is suspended from an active rigging component A consisting of a chain 5; the active rigging component A is cross-coupled to the directional clamp slot 211 of the hoisting shackle 2 and the bolt P1 is inserted and secured to achieve a chain-type active rigging component-driven movable self-locking 12 structure.

In FIG. 6, secured between the active rigging component A and the hook 12 is an insulator swivel ring B to provide for the direct welding of suspended large tools by preventing the conductance of electric current to the uppermost end during welding and the resulting hazards.

In FIG. 7, the bottom end is symmetrical with the directional clamp slot 211 of the hoisting shackle 2 and, furthermore, the top end is suspended from an active rigging component C consisting of a belt 6; the active rigging component C is cross-coupled to the directional clamp slot 211 of the hoisting shackle 2 and the bolt P1 is inserted and secured to achieve a belt-type active rigging component-driven movable self-locking hook 12 structure.

In FIG. 8, a drawing of another belt-type active rigging component embodiment, the bottom end of the said belt-type active rigging component D is symmetrical with the directional clamp slot 211 of the hoisting shackle 2, cross-coupled to the directional clamp slot 211, and the bolt P1 is inserted and secured to achieve a belt-type active rigging component-driven movable self-locking hook 12 structure.

1. A coupling self-locking hook comprised of a hook annulus body and a pivot pin inserted into a hoisting shackle at the upper extent of the body, of which:
The said body has formed in its upper lateral face a horizontally recessed U-shaped clevis section and, furthermore, situated inside the said U-shaped clevis section is a position lock.
The said hoisting shackle has formed in its boom end a plurality of upward facing openings and, furthermore, these serve as a directional clamp slot that provides for the installation of various active rigging components, with all the partition layers of the said directional clamp slot having formed in them a through-hole.
Since various active rigging components can be installed to the said boom end of the said hoisting shackle, the said self-locking hook of the present invention is suitable for applications in which active rigging components need to be installed for different situations and thereby achieves a coupling self-locking hook of high practicality.

2. As mentioned in claim 1 of the coupling self-locking hook invention herein, the said hoisting shackle is proximal to a conjoinment position which is of a stepped profile and, furthermore, proximal to the top of the said position lock is a press section; furthermore, the said hoisting shackle has projecting from the said boom end a stop tab that provides a support point for the said hoisting shackle at the said conjoinment position and its rotational situating to a maximum angle.

3. As mentioned in claim 2 of the coupling self-locking hook invention herein, the said body has the said position lock situated within and in its interior section is a torsion spring and, furthermore, the said position lock is first pivoted to change the shape of the said torsion spring until the top end of the said position lock is pushed against the said hoisting shackle, and by simply pressing downward and, furthermore, after the pressure is released, the said torsion spring is restored back to its original arrangement and situates the said hoisting shackle at the required angle.
